(19) United States
(12) Patent Application Publication
(10) Pub. No.: US 2009/0013332 A1
(43) Pub. Date: Jan. 8, 2009

(54) Special "Legacy Board" device

(76) Inventors: Deborah Ross, Muncie, IN (US); Mark Ross, Muncie, IN (US)

Correspondence Address: RITCHISON LAW OFFICES, PC, 115 EAST NINTH STREET - SUITE A, ANDERSON, IN, 46016-1507, US

(21) Appl. No.: 12/156,545

(22) Filed: Jun. 2, 2008

Related U.S. Application Data
(60) Provisional application No. 60/932,837, filed on Jun. 1, 2007.

(51) Int. Cl. G06F 9/54

(52) U.S. Cl. 719/315

(57) ABSTRACT

A unique display device called a “Legacy Board”. The device is used in remembering and memorializing the lives of loved ones. The device is related to apparatus and methods to hold a collection of family pictures, documents, artwork and other memorabilia and is used to showcase occasions such as births, baptisms, birthdays, graduations, engagements, reunions, weddings, anniversaries, death and memorials. The device is comprised of a base foam backboard; a predetermined placement template on the backboard with which to place the family collection onto the board; a means to removably attach the collection objects to the board; and a group of pre-cut openings, that correspond and match the placement template in order to reveal the items of the collection, through one or more sheets of flexible, thin and transparent or translucent material which feature stylish artwork images with/without text. The device may be framed or unframed.

### CROSS-REFERENCE TO RELATED APPLICATIONS:

This application claims the benefit of Provisional Patent Application Ser. No. 60/932837 filed Jun. 1, 2008 by Deborah Ross and Mark Ross and entitled Special “Legacy Board” Device.

### FIELD OF INVENTION

This invention relates to a Special “Legacy Board” Device for use in remembering and memorializing the personal circumstances and lives of loved ones. Particularly this new Special “Legacy Board” Device is related to devices and methods to hold a collection of family pictures, documents, artwork and memorabilia. This Special “Legacy Board” Device may be featured as a framed or unframed collection to showcase special occasions such as births, baptisms, birthdays, graduations, engagements, reunions, weddings, anniversaries, death and memorials. The preferred embodiment is described below.

### FEDERALLY SPONSORED RESEARCH

None.

### SEQUENCE LISTING OR PROGRAM

None.

### BACKGROUND-FIELD OF INVENTION AND PRIOR ART

The unique and new Special “Legacy Board” Device described in this specification is a display device and system that is designed to easily be used to show pictures, memorabilia and other objects of an individual or group. It is initially designed for use in funeral homes to display a history of a loved one in conjunction with the celebration of that person's life. It is easily adaptable to other special occasions such as births, baptisms, birthdays, graduations, engagements, reunions, weddings, anniversaries, death and memorials.

A. Introduction of the Problems Addressed

Traditionally, the display devices to date are not adaptable and easy to use. Often they are framing means or non-standard boards that lack any uniformity or ease of use. The singular devices that are not usable for many occasions and leave the problem of designing a board for each use—one at a time. The Special “Legacy Board” Device provides a device that is versatile, memorable, simple to use, light weight; economical, and easy to use.

B. Prior Art

The historical technology focused mainly on singular picture devices, story boards and placemats. All with limited focus and not easy to use. Devices have attempted to address single or multiple object needs but are not easily adaptable for universal displays. This new device addresses these limitations and provides a solution to the stated problems.

Examples of prior display devices begin with U.S. Pat. No. 3,813,799 issued to Caravello (1974) and entitled “Picture frame for framing and holding a plurality of pictures” 45. This invention teaches a picture frame for framing and holding a plurality of pictures in predetermined orientation, comprising a back support frame, an intermediate picture receiving frame having a plurality of pockets therein for receiving pictures and having a plurality of openings in registry with the pockets for displaying pictures in the pockets, and a front support frame having a plurality of openings for displaying the pictures in the pockets. The means to hold and rapid ease to change of the Special “Legacy Board” Device is not shown or anticipated here.

A further example of a display system is shown by Weiner in U.S. Pat. No. 4,899,473 (1990) and entitled “Picture Frame Assembly” 46. This teaches a traditional picture frame assembly that includes a frame of various types of common materials. The frame defines a viewing window which may be covered by a sheet of transparent glass or plastic in the frame. A backboard is used in the frame behind the window, which backboard includes an outer frame-supporting perimeter and an openable, hinged, generally central portion. When closed, the central portion also supports the frame. A mask is disposed between the backboard and sheet of glass or plastic and may be a separate sheet. Support inserts may be secured to the back of the frame over the backboard and optionally releasably hold a central portion closed. No mention of non-traditional use or lightweight display means for special occasions are taught.

In the U.S. Pat. No. 5,096,752 (1992), Wagner received a patent entitled “Placemat with changeable card display” 48. This taught a mat that includes a front panel having a plurality of rectangular cut outs dimensioned to accommodate cards bearing the likeness of celebrities such as athletes. Each of the cut outs is covered with a clear plastic film overlay to provide a window for viewing the cards. A base panel is laminated to the front panel and encloses the cut outs to form a pocket for each card. Provided in the base panel adjacent an edge of each cut out is a slot for insertion and removal of cards. The front panel is imprinted with indicia coordinated with the activity of the celebrities depicted on the cards to be inserted in the various pockets. The invention is relatively small for use on a table top and is not compatible with the features and function of the new Special “Legacy Board” Device.

Another U.S. Pat. No. 5,733,166 (1999) was issued to Hoag and is entitled “Story board with attachable elements” 47. This teaches a story board with attachable elements for being secured to a wall, with the associated set of dolls being individually and releasably secured thereto. A plurality of loop members are provided along the top border to enable the securement of the story board to a wall. The front panel of the story board is sectioned into a grid of individual panels for a particular scene, in similar fashion to a conventional story board. A pocket is carried by selected of the individual panels for storing various selected items. The secured device on a wall fails the display-ability of the unique Special “Legacy Board” Device as to addressing the stated problems.

As far as known, there are no other devices at the present time which fully provide these improvements and functional characteristics as the present Special “Legacy Board” Device. It is believed that this device is made with improved configurations and physical features to provide more functionality when compared to other currently utilized display methods such as cumbersome picture frames or plain foam boards. To the best knowledge of the inventor, this combination and use has not been anticipated by other products, patents or combinations of patents in view of each other. The particular combinations of materials and features are unique and novel and are not anticipated by prior art. Likewise, by using a Special “Legacy Board” Device a more professional and aesthetic result may be achieved.

### SUMMARY OF THE INVENTION

A Special “Legacy Board” Device has been developed and designed to celebrate life. The Definitions for Legacy are:

(1.) bequest made in will: money or property that is left to somebody in a will, and

(2.) something from past: something that is handed down or remains from a previous generation or time. Here the “Legacy Board” anticipates a market initially to funeral homes but this will not limit the device to use in funeral homes only as it may have a market elsewhere. The Special “Legacy Board” Device may be used to showcase any special occasions such as births, baptisms, birthdays, graduations, engagements, reunions, weddings, anniversaries, death and memorials.

The preferred embodiment of the Special “Legacy Board” Device is comprised of a base foam backboard, or equal; a predetermined placement template on the backboard with which to place a user's collection of family pictures, documents, artwork and memorabilia onto the board; a means to removably attach the user's collection objects to the board; a group of pre-cut openings (that corresponds and matches the placement template in order to reveal the items of the collection) through one or more sheets of flexible, thin and transparent or translucent material which feature stylish artwork images with/without text. The board may be framed or unframed as desired.

### OBJECTS AND ADVANTAGES

There are several objects and advantages of the Special “Legacy Board” Device. There are currently no known display and story board devices that are effective at providing the objects of this invention.

The following TABLE A summarizes various advantages and objects of the Special “Legacy Board” Device. This list is exemplary and not limiting to the many advantages offered by this new device.

TABLE A
Various Advantages and Objects

| Item | | Description of Advantage and Object |
|---|---|---|
| 1 | Versatile | may be used to showcase special occasions |
| | | such as funerals, births, baptisms, birthdays, |
| | | graduations, engagements, reunions, weddings, |
| | | anniversaries, death and memorials |
| 2 | Memorable | Family and friends can celebrate their |
| | | heritage with the Legacy Board |
| 3 | Simple | Decorative story board can tell a person's |
| | | life story through photographs, documents, |
| | | artwork and memorabilia. The concept is similar |
| | | to scrap book but requires less work |
| 4 | Professional | Themed boards with custom artwork |
| 5 | Economical | Mass produced |
| 6 | Easy to use | No assembly required, comes pre-assembled |
| | | (just add snapshots) or frame if desired and |
| | | very lightweight |

Noteworthy is that other advantages and additional features of the present Special “Legacy Board” Device will be more apparent from the accompanying drawings and from the full description of the device. For one skilled in the art of devices, improvements and handling of the display of photographs, memorabilia and other personal items, it is readily understood that the features shown in the examples with this device is readily adapted for improvement to other types of display means.

### DESCRIPTION OF THE DRAWINGS—FIGURES

The accompanying drawings, which are incorporated in and constitute a part of this specification, illustrate a preferred and alternative embodiments for the Special “Legacy Board” Device. The drawings together with the summary description given above and a detailed description given below serve to explain the principles of the Special “Legacy Board” Device. It is understood, however, that the device is not limited to only the precise arrangements and instrumentalities shown.

FIGS. 1 A and 1 B depict the general components of the preferred and alternative embodiments for the Special “Legacy Board” Device.

FIGS. 2 A through 2 C show details and features of the preferred embodiment of the Special “Legacy Board” Device.

FIGS. 3 A through 3 F show details and features of the alternative embodiment of the Special “Legacy Board” Device.

FIG. 4 A through 4 C show additional common details for the embodiments of the Special “Legacy Board” Device.

FIGS. 5 A through 5 D are sketches of the Special “Legacy Board” Device with features shown.

FIGS. 6 A and 6 B are edge options for the Special “Legacy Board” Device.

FIGS. 7 A through 7 C are examples of how to mount or display the Special “Legacy Board” Device.

FIGS. 8 A through 8 D are examples of prior art in the fields of photographs, story boards and other display devices.

### DESCRIPTION OF THE DRAWINGS—REFERENCE NUMERALS The following list refers to the drawings:

| Ref # | Description |
|---|---|
| 31 | Preferred embodiment for the Special “Legacy Board” |
| | Device |
| 31A | Alternative embodiment for the Special “Legacy Board” |
| | Device |
| 32 | Cover sheet and template for Special “Legacy Board” |
| | Device |
| 32A | Additional cover sheet(s) for the Special “Legacy |
| | Board” Device |
| 33 | Aperture or opening for the pictures or memorabilia |
| 34 | Back side of cover sheets 32 |
| 34A | Back side of multiple (2^{nd}, 3^{rd}, etc) cover sheets 32A |
| 35 | Foam board or equal lightweight backing |
| 36 | pictures or memorabilia |
| 37 | pictures or memorabilia section of cover sheets 32 and |
| | 32 A |
| 38 | Upper Title or verse are for section of cover sheets 32 |
| | and 32 A |
| 38A | Lower Title or verse are for section of cover sheets 32 |
| | and 32 A |
| 39 | Specific Title or verse for the Special “Legacy Board” |
| | Device |
| 40 | No frame option for the Special “Legacy Board” Device |
| 41 | Framed option for the Special “Legacy Board” Device |
| 42 | Example of a wall mount display method |
| 43 | Example of an easel mount display method |
| 44 | Example of a chart pack mount display method |
| 45 | Prior art U.S. Pat. No. 3,813,799 |
| 46 | Prior art U.S. Pat. No. 4,899,473 |
| 47 | Prior art U.S. Pat. No. 5,733,166 |
| 48 | Prior art U.S. Pat. No. 5,096,752 |
| 49 | Means to attach pictures and memorabilia 36 to foam |
| | board 35 (not shown) |
| 50 | Means to frame Special “Legacy Board” Device 31 |
| | creating a framed device 41 |

### DETAILED DESCRIPTION OF PREFERRED EMBODIMENT

The present invention presented is a Special “Legacy Board” Device 31 for use in remembering and memorializing the personal circumstances and lives of loved ones. Particularly the preferred embodiment of the Special “Legacy Board” Device 31 is related to devices and methods to hold a collection of family pictures, documents, artwork and memorabilia 36. This Special “Legacy Board” Device 31 may be featured as a framed 41 or unframed 40 collection to showcase special occasions such as births, baptisms, birthdays, graduations, engagements, reunions, weddings, anniversaries, death and memorials. The preferred embodiment is described below.

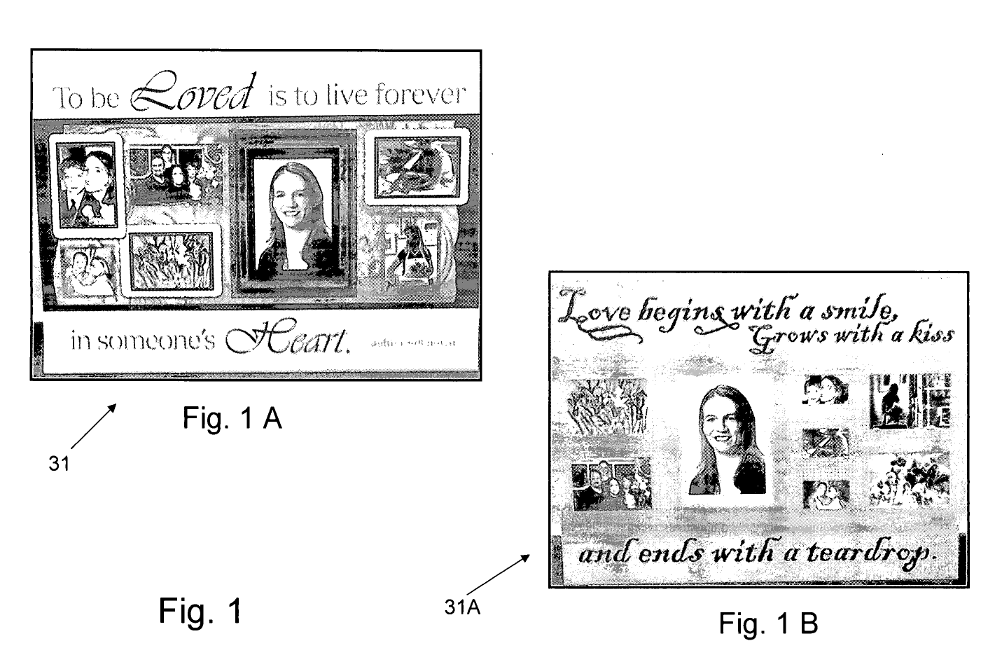

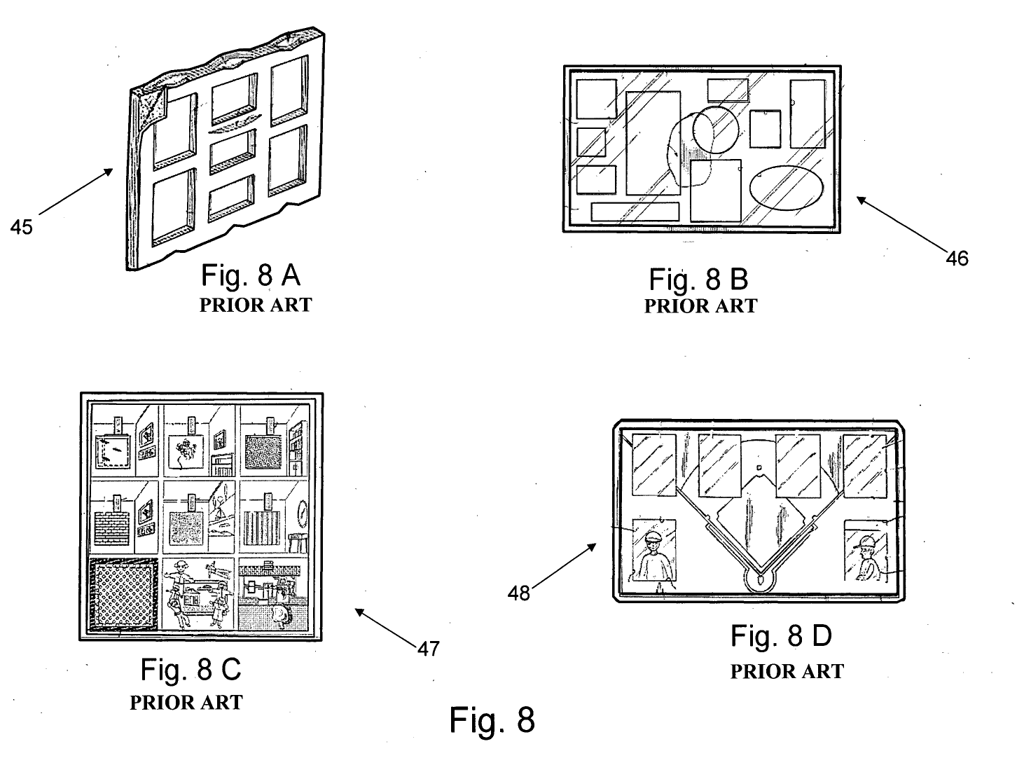

There is shown in FIGS. 1-7 a complete detail and operative embodiment of the Special “Legacy Board” Device 31. In the drawings and illustrations, one notes well that the FIGS. 1-6 demonstrate the general configuration and FIG. 7, the use of this invention. FIGS. 8 A through 8 D demonstrate some of the prior art for display means. The operation of the device 31 and are discussed below in the Operations section.

The advantages, restated are:

1. Versatile.

2. Memorable.

3. Simple to use.

4. Light weight.

5. Economical.

6. Easy to use.

The preferred embodiment of the Special “Legacy Board” Device 31 is comprised of a base foam backboard 35, or equal; a predetermined placement template 32 (same as the cover sheet configuration) on the backboard 35 with which to place a user's collection of family pictures, documents, artwork and memorabilia 36 onto the backboard 35; a means to removably attach 49 the user's collection objects 36 to the backboard 35; a group of pre-cut openings 33 (that corresponds and matches the placement template 32 in order to reveal the items of the collection) through one or more sheets 32, 32A of flexible, thin and transparent or translucent material which feature stylish artwork images with/without text. The board may be framed 41 or unframed 40 as desired.

The accompanying drawings, which are incorporated in and constitute a part of this specification, illustrate a preferred 31 and alternative 31A embodiment of the Special “Legacy Board” Device. The drawings together with the summary description given above and a detailed description given below serve to explain the principles of the Special “Legacy Board” Device 31. It is understood, however, that the Special “Legacy Board” Device 31 is not limited to only the precise arrangements and instrumentalities shown.

FIGS. 1 A and 1 B depict the general components of the preferred 31 and alternative 31A embodiments for the Special “Legacy Board” Device. The devices are described by the features and functions of their components, below.

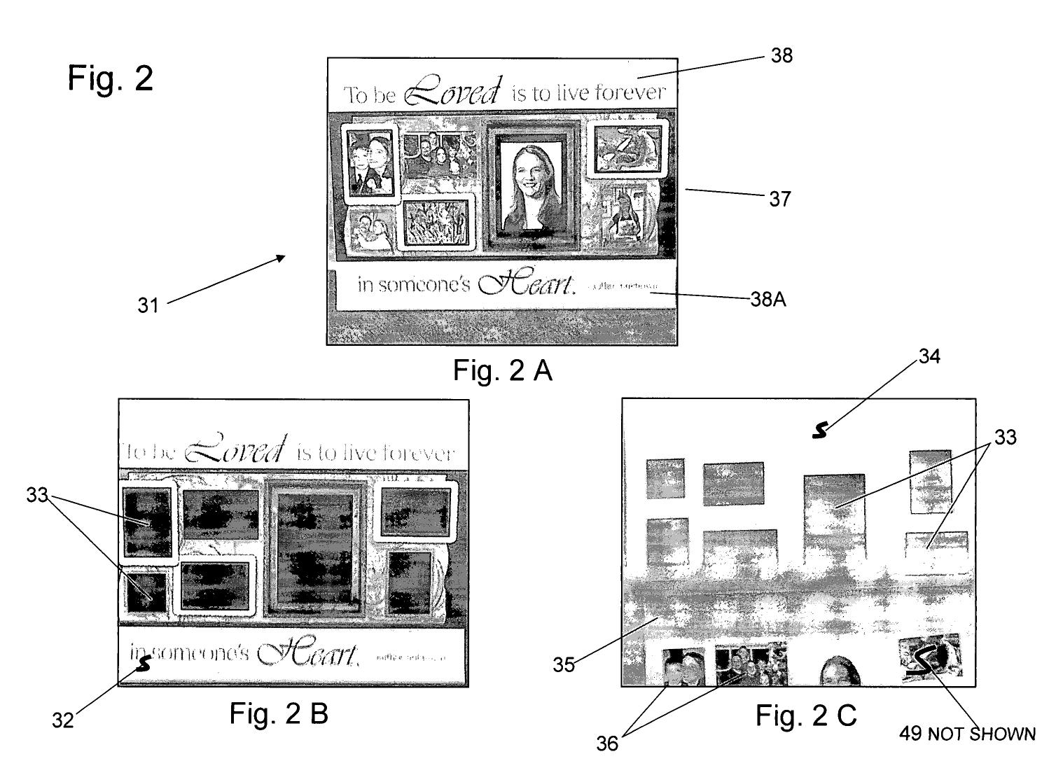

FIGS. 2 A through 2 C show details and features of the preferred embodiment of the Special “Legacy Board” Device 31. FIG. 2 A is a photograph of a prototype sample of the Special “Legacy Board” Device 31. The general title or verse block 38 is depicted as well as a lower area 38A for additional text or artistic designs. In the center area of the device 31 is an area for the memorabilia placement 37. One skilled in the art of display units understands that the general dimensions and size of the device 31 may vary in size and shape. The size may for example be 2 feet by 3 feet, larger or smaller and still be in the spirit and scope of the Special “Legacy Board” Device 31. Likewise the example is essentially rectangular in shape, but could take on the configuration of other polygons, circles, ellipses, ovals and a virtual plethora of other geometrical shapes. These are exemplary in nature and not limiting in scope of the shape of the device or board.

FIG. 2 B presents the device 31 with the picture and memorabilia apertures 33 shows in the cover sheet 32. The outermost cover 32 may have alpha-numeric characters of various fonts as well as various artistic designs to give a theme. The characters may be shown in various desired languages within the scope and spirit of the Special “Legacy Board” Device 31. The perimeter of the apertures 33 may have designs to essentially “mimic” a frame or no frame, as desired. The sheet 32 may be a transparent or translucent material such as a heavy paper, mylar, or other composite materials that are flexible and durable. Preferably these materials may be configured in various perimeter shapes and processed to give the apertures 33 by rapid, mass production methods well known in the paper and plastic processing industry. The apertures 33 may be cut or punched in place or even etched or “burnt” in place by a laser or the like. Further, the individual apertures 33 may be of various sizes and shapes such as rectangular, circular, elliptical, and other geometrical shapes.

In FIG. 2 C, the backside 34 of the cover sheet 32 is displayed as a flexible cover sheet turned back. The apertures 33 are in view and the flexibility of the cover sheet 32 to be moved for placement of the photographs and memorabilia 36 onto the backboard 35 by an attachment means 49. The backboard 35 is of a durable material such as a cardboard, foam board or other flat, lightweight composite material, plastic, or metal (such as aluminum or thin sheet steel). The thickness may vary as well, as long as it has been empirically confirmed to be rigid enough to hold its shape when the memorabilia 36 is attached. The means of removable attachment 49 may also vary from a simple sticky adhesive, mechanical means such as pins or staples, or by a more complex means such as “loop and hook” designs demonstrated by Velcro® or the like.

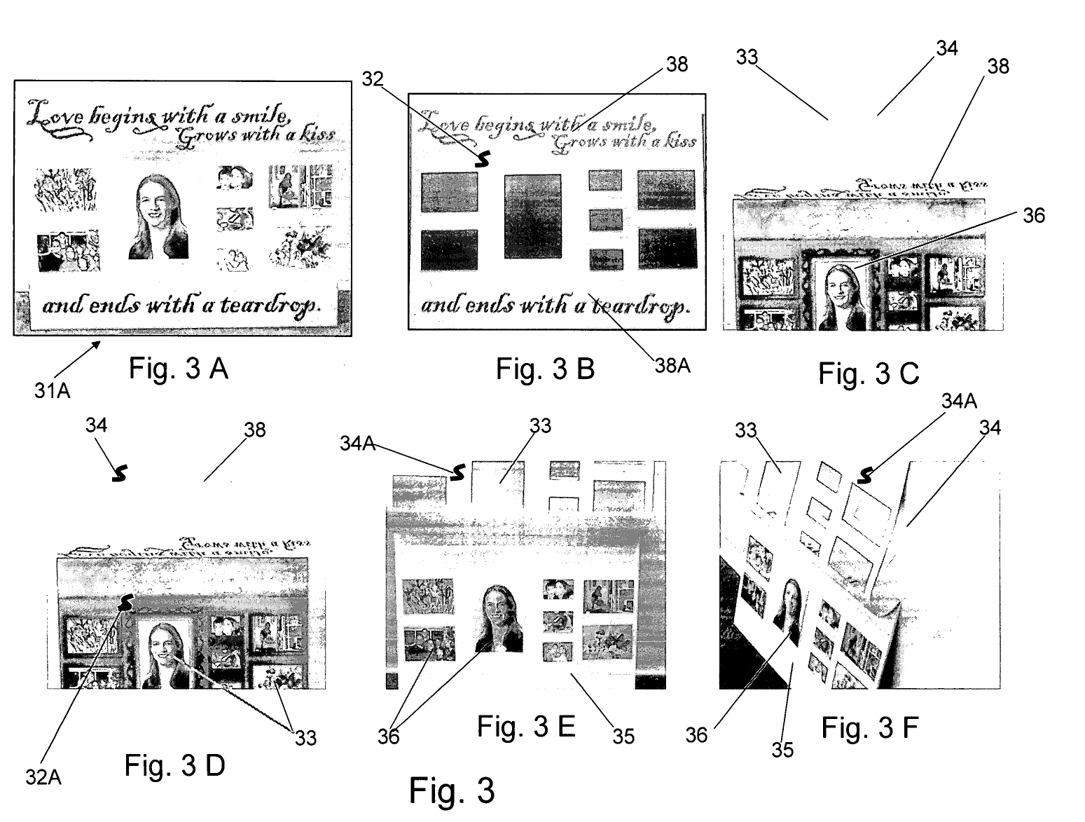

FIGS. 3 A through 3 F show details and features of the alternative embodiment 31A of the Special “Legacy Board” Device. Here in the alternative embodiment 31A, the component sheets 32 and back 34 with apertures 33 and titles 38 and 38A are similar to the preferred embodiment 31 as described above. Note a difference in the aperture layout 33 with different sizes and layout is exemplary and not limiting. As stated, the size, shape and number of apertures is limited only by the size of the board 35 and the imagination of the creator of the art. What is different here it the example of a plurality of sheets 32, 32A. Again, additional sheets 32, 32A may be used to give design effects as to the artwork, style and titles or verses 38. FIG. 3 F shows two sheets 32 and 32A from the back sides 34, 34A and the foam backboard 35 (for example) with memorabilia and pictures 36 mounted by a means of attachment 49 (not shown). The rest of the details for FIG. 3 are essentially similar if not the same as described in FIG. 2, described above.

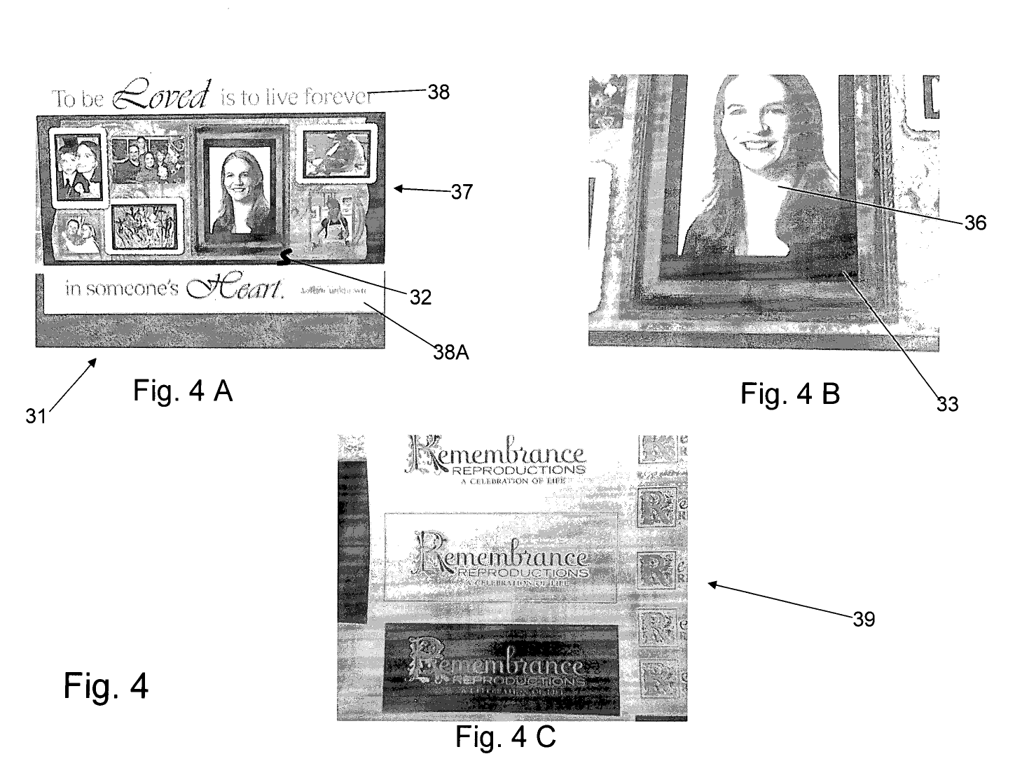

FIG. 4 A through 4 C show additional common details for the preferred and alternative embodiments of the Special “Legacy Board” Device 31, 31A. The title and text areas 38, 38A are shown. The general picture area 37 is depicted. A photograph 36 shows various “frames” may be placed surrounding the aperture 33 for effects. Likewise, various predetermined text 39 may be selected or a special custom title may be produced.

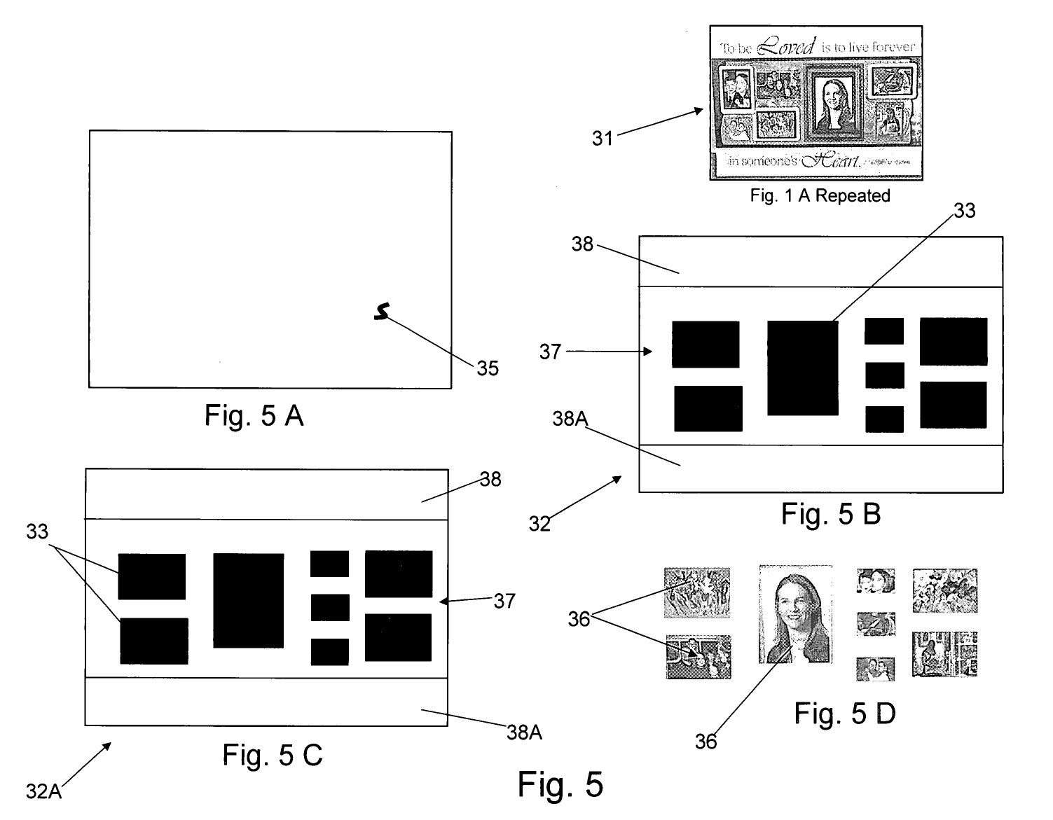

FIGS. 5 A through 5 D are sketches of the Special “Legacy Board” Device 31 with features shown in the prototype photographs described above. The back board 35 such as a foam board for example (not limitation) is in a geometric shape. Here is exemplified a rectangle. The title block 38 and lower text block 38A is shown above and below the photograph and memorabilia area on cover sheet 32. A very important point is that a cover sheet 32 is essentially a layout template 32 for use on the backboard 35, when one desires to lay out the memorabilia and photographs. The apertures 33 then align with the sheets 32 and 32A (shown in FIGS. 5 B and 5 C. Finally, photographs and other memorabilia 36 are exemplified, yet not limited to the series shown in FIG. 5 D.

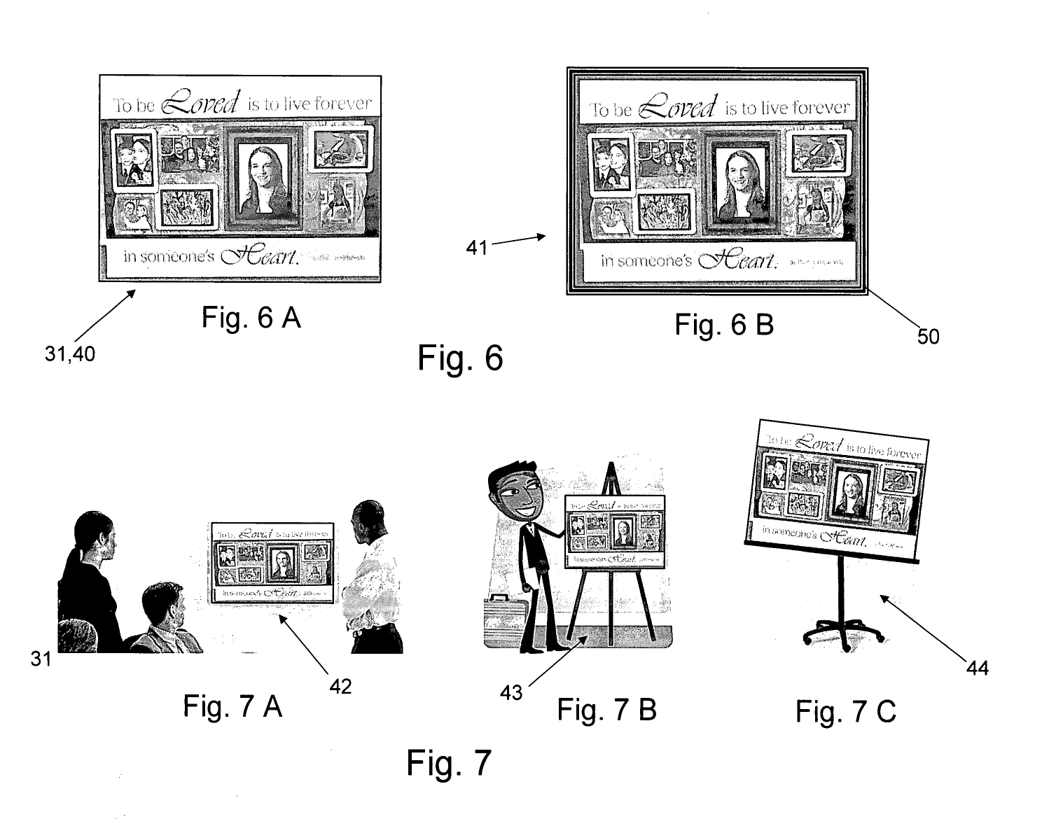

FIGS. 6 A and 6 B are edge options for the Special “Legacy Board” Device. The plain edged, unframed option 31,40 is shown in FIG. 6 A. This is the least complex configuration. A framed option 41 is depicted by FIG. 6 B. The frame 50 may be similar to well known frames (for pictures) or a half side frame that can be placed over the cover sheets and held in place by some means such as a removable adhesive or simple mechanical fasteners such as pins, staples, clamps or spring mechanisms

FIGS. 7 A through 7 C are examples of how to mount or display the Special “Legacy Board” Device. This is discussed below in the operation section.

FIGS. 8 A through 8 D are examples of prior art in the fields of photographs, story boards and other display devices. The patents are summarized as:

| Item | Patent Number | Title | Inventor | Year |
|---|---|---|---|---|
| 47 | 5,733,166 | Story board with | Hoag | 1999 |
| | | attachable elements | | |
| 48 | 5,096,752 | Placemat with | Wagner | 1992 |
| | | changeable card display | | |
| 46 | 4,899,473 | Picture Frame Assembly | Weiner | 1990 |
| 45 | 3,813,799 | PICTURE FRAME FOR | Caravello | 1974 |
| | | FRAMING AND HOLDING | | |
| | | A PLURALITY OF | | |
| | | PICTURES | | |

All of the details mentioned here are exemplary and not limiting. Other components specific to describing a Special “Legacy Board” Device 31 may be added as a person having ordinary skill in the field of memorabilia and photograph displays and story boarding techniques well appreciates.

### OPERATION OF THE PREFERRED EMBODIMENT

The preferred 31 and alternative 31 A embodiments for the Special “Legacy Board” Device 31 have been described in the above paragraphs. The manner of how the device operates is described below. One skilled in the art of memorabilia and photograph displays and story boarding techniques will note that the description above and the operation described here must be taken together to fully illustrate the concept of the Special “Legacy Board” Devices 31, 31 A.

The preferred embodiment of the Special “Legacy Board” Device 31 is comprised of a base foam backboard 35, or equal; a predetermined placement template 32 (same as the cover sheet configuration) on the backboard 35 with which to place a user's collection of family pictures, documents, artwork and memorabilia 36 onto the backboard 35; a means to removably attach 49 the user's collection objects 36 to the backboard 35; a group of pre-cut openings 33 (that corresponds and matches the placement template 32 in order to reveal the items of the collection) through one or more sheets 32, 32 A of flexible, thin and transparent or translucent material which feature stylish artwork images with/without text. The board may be framed 41 or unframed 40 as desired.

Here the use of the “Legacy Board” anticipates a market initially to funeral homes but this will not limit the device to use in funeral homes only as it may have a market elsewhere. The Special “Legacy Board” Device 31 may be used to showcase any special occasions such as births, baptisms, birthdays, graduations, engagements, reunions, weddings, anniversaries, death and memorials.

The method of assembling and using the Special “Legacy Board” Device 31 are summarized in the following Table A.

TABLE A
Method for Use

| STEP | Description |
|---|---|
| 1 | Select the size of the board desired 35 |
| 2 | Select an appropriate template 32 |
| 3 | Decide and select the cover sheets 32, 32A |
| 4 | Decide on the theme - wording and stylish design |
| 5 | Gather the memorabilia, photographs, etc 36 |
| 6 | Mount memorabilia 36 to backboard 35 by the means to |
| | attach 49 |
| 7 | Display by a means exemplified in FIG. 7 |

FIGS. 7 A through 7 C are examples of how to mount or display the Special “Legacy Board” Device 31. The firsts example is a simple wall mount 42 shown in FIG. 7 A. Next, an easel mount 43 is shown in FIG. 7 B. The final example is a chart pack mount 44 as depicted in FIG. 7 C. Other manners may be used to mount the Special “Legacy Board” Device 31, such as ceiling mounts with chains, cords, wires, cables or the like. With the above description it is to be understood that the Special “Legacy Board” Device 31 is not to be limited to only the disclosed embodiment. The features of the Special “Legacy Board” Device 31 are intended to cover various modifications and equivalent arrangements included within the spirit and scope of the description.

What is claimed is:

1. A Special “Legacy Board” Device with features is comprised of
(a) a base backboard made of a durable material with features;
(b) a predetermined placement template with a group of markable locations on the backboard with which to place a user's collection of objects of family pictures, documents, artwork and memorabilia onto the board;
(c) a means to removably attach the objects to the board;
(d) at least one sheet of essentially translucent material with at least one pre-cut openings that corresponds and matches the placement template locations in order to reveal the objects of the collection through the sheets, the outer most sheet with exposed features
wherein the device may be displayed and mounted to professionally showcase special occasions such as births, baptisms, birthdays, graduations, engagements, reunions, weddings, anniversaries, death and memorials.

2. The device according to claim 1 wherein the durable material of the backboard is a composite material.

3. The device according to claim 2 wherein the composite material is plastic.

4. The device according to claim 2 wherein the composite material is a durable compressed fiber board.

5. The device according to claim 1 wherein the material is a metal.

6. The device according to claim 1 wherein the durable material of the backboard is a stiff foam material.

7. The device according to claim 1 wherein Special Legacy device feature is a frame.

8. The device according to claim 1 wherein the backboard feature is essentially configured as a geometric shape.

9. The device according to claim 8 wherein the geometric shape is a polygon.

10. The device according to claim 9 wherein the polygon shape is a rectangle.

11. The device according to claim 8 wherein the geometric shape is an ellipse.

12. The device according to claim 11 wherein the ellipse shape is a circle.

13. The device according to claim 1 wherein the means to attach is a re-stick able adhesive.

14. The device according to claim 1 wherein the means to attach is a hook and loop system.

15. The device according to claim 1 wherein the essentially translucent material is made of mylar.

16. The device according to claim 1 wherein the essentially translucent material is made of a thin, clear and transparent plastic sheet.

17. The device according to claim 1 wherein the exposed features of the outermost sheet is stylish artwork.

18. The device according to claim 17 wherein the artwork has text.

19. The device according to claim 17 wherein the artwork is on the inner surface of the sheet and is visible through the essentially translucent sheet.

20. An essentially rectangular Special “Legacy Board” Device that is framed and is comprised of
(a) a base backboard made of a durable foam material with features;
(b) a predetermined placement template with a group of markable locations on the backboard with which to place a user's collection of objects of family pictures, documents, artwork and memorabilia onto the board;
(c) a sticky yet removable adhesive to removably attach the objects to the board;
(d) at least one sheet of flexible, thin and transparent material with at least one pre-cut openings that corresponds and matches the placement template locations in order to reveal the objects of the collection through the sheets, the outer most sheet with exposed features
wherein the device may be displayed and mounted to professionally showcase special occasions such as births, baptisms, birthdays, graduations, engagements, reunions, weddings, anniversaries, death and memorials.
